(19) United States
(12) Patent Application Publication
(10) Pub. No.: US 2024/0334230 A1
(43) Pub. Date: Oct. 3, 2024

(54) CONFIGURATION OF SENSING SIGNAL AND SENSING RESULTS REPORTING

(71) Applicant: APPLE INC., CUPERTINO, CA (US)

(72) Inventors: Ping-Heng Kuo, London (GB); Peng Cheng, Beijing (CN); Ralf Rossbach, Munich (DE); Alexander Sirotkin, Herzliya (IL); Zhibin Wu, Los Altos, CA (US); Fangli Xu, Beijing (CN); Yuqin Chen, Beijing (CN); Naveen Kumar R. Palle Venkata, SAN DIEGO, CA (US)

(73) Assignee: APPLE INC., CUPERTINO, CA (US)

(21) Appl. No.: 18/592,511

(22) Filed: Feb. 29, 2024

Related U.S. Application Data
(60) Provisional application No. 63/456,376, filed on Mar. 31, 2023.

(51) Int. Cl. H04W 24/10; H04L 5/00

(52) U.S. Cl. CPC H04W 24/10; H04L 5/0048

(57) ABSTRACT

The present application relates to devices and components, including apparatus, systems, and methods for configuring sensing signals and reporting results.

### CROSS-REFERENCES TO OTHER APPLICATIONS

This application claims priority to U.S. Provisional Application No. 63/456,376, for “CONFIGURATION OF SENSING SIGNAL AND SENSING RESULTS REPORTING TECHNICAL FIELD,” filed on Mar. 31, 2023, which is herein incorporated by reference in its entirety for all purposes.

### TECHNICAL FIELD

This application generally relates to cellular communication networks and, in particular, to technologies for sensing and localization.

### BACKGROUND

Sensing and localization may be used for weather condition monitoring or detection and tracking of objects. Sensing may be performed based on monostatic sensing or bistatic sensing. In monostatic sensing, co-located antennas transmit and receive the sensing signal. In bistatic sensing, the transmitting and receiving antennas are geographically separated.

### BRIEF DESCRIPTION OF THE DRAWINGS

FIG. 1 illustrates a network environment in accordance with some embodiments

FIG. 2 illustrates signaling and timing diagrams in accordance with some embodiments

FIG. 3 illustrates signaling and timing diagrams in accordance with some embodiments

FIG. 4 illustrates a configuration diagram in accordance with some embodiments

FIG. 5 illustrates a configuration diagram in accordance with some embodiments

FIG. 6 illustrates a configuration diagram in accordance with some embodiments

FIG. 7 illustrates a timing diagram in accordance with some embodiments

FIG. 8 illustrates an operational flow/algorithmic structure in accordance with some embodiments

FIG. 9 illustrates an operational flow/algorithmic structure in accordance with some embodiments

FIG. 10 illustrates a user equipment in accordance with some embodiments FIG. 11 illustrates a network node in accordance with some embodiments

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; central processing unit (CPU); graphics processing unit; single-core processor; dual-core processor; triple-core processor; quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

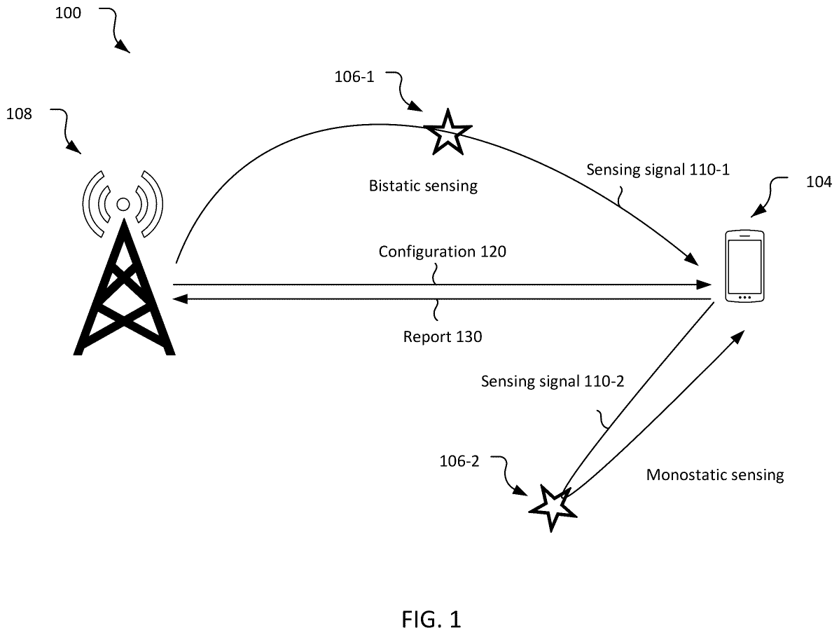

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

Sensing and localization may be considered inherent features of mobile communication technologies. The sensing may be used to detect/monitor/track conditions (for example, weather conditions), objects (for example, objects not carrying a UE), or phenomena. Sensing may additionally/alternatively be used to aid communication to adjust to the radio frequency (RF) and physical layer (PHY) configurations. A network device, e.g., the UE 104 or the BS 108, may perform monostatic sensing in which the network device transmits and receives the sensing signal. In an instance of monostatic sensing, the same antenna or co-located antennas may be used for both transmission and reception. For example, monostatic sensing may include a first antenna(s) for transmitting a sensing signal and a co-located second antenna(s) for receiving the sensing signal. In monostatic sensing, it is understood that ‘transmitting and receiving sensing signal’ means ‘transmitting the sensing signal and receiving a reflection of the transmitted sensing signal.’ A network device, e.g., the UE 104 or the BS 108, may perform bistatic sensing in which the network device receives the sensing signal transmitted by another network device. In one instance of bistatic sensing, two separate antennas are used for transmitting and receiving, and the transmitting antenna(s) are in a different location than the receiving antenna(s).

The network may provide sensing services to applications and devices not part of the network. For example, an application or a client may request sensing services from a network device. The network device may perform the sensing measurements and provide the result to the application or the client.

For example, in a monostatic sensing from a UE, the UE 104 sends the sensing signal 110-2 and receives the reflection of the sensing signal 110-2 caused by the object 106-2. The UE 104 may measure and analyze the received reflected signal to detect the existence of the object 106-2. While not specifically shown, monostatic sensing may be performed by base station 108 in a similar manner.

In an example of bistatic sensing, the BS 108 (or another UE) may send the sensing signal 110-1. The UE 104 may receive the reflection of the sensing signal 110-1 caused by the object 106-1. The UE 104 may measure and analyze the received reflected signal to detect the existence of the object 106-1.

In bistatic or monostatic sensing at the UE 104, the UE 104 may receive sensing signals 110-1 or 110-2, collectively referred to as sensing signal 110. The UE 104 may perform measurements on the received sensing signal 110 to detect objects 106-1 or 106-2, collectively referred to as object 106. The UE 104 may send report 130 to the entity requesting the sensing service to convey the result of the measurements. The sensing signal 110 could be any waveform that can be used for purposes of sensing, including a reference signal defined by 3GPP, a signal carrying data payload, a signal carrying control information, or a non-3GPP signal waveform.

The BS 108 may send the configuration signal 120 to the UE 104 to configure the UE 104 to perform sensings. The BS 108 may configure the UE 104 to perform sensing for different purposes. For example, the BS 108 may configure the UE 104 to send multiple sensing signals for different sensing sessions. The configuration signal may configure the sensing signal, e.g., the sequence, the resources, the periodicity, and power control. The configuration signal may configure the UE 104 with the reporting parameters, such as the parameter to be measured or detected, reporting resources, e.g., time, frequency, and power resources, and periodicity of sending the report 130.

In one instance of monostatic sensing, the network may initiate a request for sensing. For example, the network may receive a demand from an external client for a sensing session to detect the presence of object 106-2. The network may identify the UE 104 for performing the sensing and configure the UE 104 to perform the sensing and report the result. The UE 104 transmits the sensing signal, e.g., the sensing signal 110-2, and measures the reflected signal to detect the presence of object 106-2. The UE 104 may send the result to the network in report 130. The network may send the sensing result to the client requesting the sensing services. The network may be a core network entity or the BS 108. In some instances, the UE 104 may initiate sensing signal transmission by itself without any request from the network. The service consumer or the client may be a client outside the network, a network function, or an application.

Sensing service may be associated with quality of service (QOS) attributes. One QoS attribute may be the accuracy of sensing. For example, the accuracy of the estimated location of object 106, or the accuracy of the direction of object 106 or the UE 104, e.g., the roll, pitch, and yaw. The QoS attributes may include refresh rate, e.g., the rate at which new location estimates need to be obtained by the application, or the minimum and maximum resolvable range, e.g., required minimum and maximum distinguishable distance between two objects. The QoS attributes may include minimum and maximum velocity, e.g., the velocity range of object 106 that needs to be measured by the sensing service, or the velocity resolution, e.g., the minimum measurable change in the velocity of object 106. The QoS attributes may include angular resolution, e.g., the required minimum distinguishable angle between two objects, the resource constraint, or a scalability requirement. The QoS attributes may include sensing service round trip time (RTT) requirement, e.g., maximum tolerable service latency from the request is issued by the consumer (application, service) until location/sensing response is provided. The service RTT requirement can vary depending on the consumer and the purpose of the sensing service. The RTT requirement impacts the reporting of the sensing results in the uplink.

A framework for sensing signal configuration and sensing result reporting is desired to ensure the reporting of the sensing results that meet the diverse QoS requirements. A flexible framework is provided in one embodiment, e.g., by configuration 120, configuring sensing signal transmission or measurement with sensing result reporting configuration. For example, the reporting configuration may include radio bearer selection in accordance with Qos requirements. In another embodiment, dynamic control and event-triggered sensing signal transmission, measurement, or reporting may provide non-periodic, on-demand sensing services.

The network, e.g., the BS 108, may configure the UE 104 with one or more sensing signal configurations. The sensing signal configuration provides details about how the UE 104 may send a sensing signal. For example, the sensing signal configuration may determine the beam width or beam direction, power level, radio resources for sensing signal transmission, radio resources for measurement, or whether the sensing signal is periodic or non-periodic. A sensing signal may be associated with a sensing signal configuration. In one example, sensing signal configuration indicates the associated sensing signal.

The sensing signal configuration may be associated with a sensing result reporting configuration. The sensing result reporting configuration indicates the reporting configuration the UE 104 may apply to report the sensing result obtained from the sensing signal associated with the sensing signal configuration. In one embodiment, the BS 108 configures the sensing result reporting configurations independent of and separate from the sensing signal configurations. For example, the BS 108 may associate a sensing result reporting configuration with a sensing signal configuration by including the report configuration identification (ID) of a sensing result reporting configuration in the sensing signal configuration. In another embodiment, the sensing result reporting configuration is embedded in the sensing signal configuration. For example, the sensing signal configuration may include the details of the sensing result reporting configuration. For example, the sensing result reporting configuration may include an indication of whether the reporting is periodic or non-periodic, reporting periodicity in case of periodic reporting, radio resources for reporting, quality of service (Qos) flow selection, or a radio bearer selection.

In one embodiment, the BS 108 may configure the UE 104 with one or more sensing sessions. Each sensing session may be associated with a sensing signal configuration and a sensing result reporting configuration.

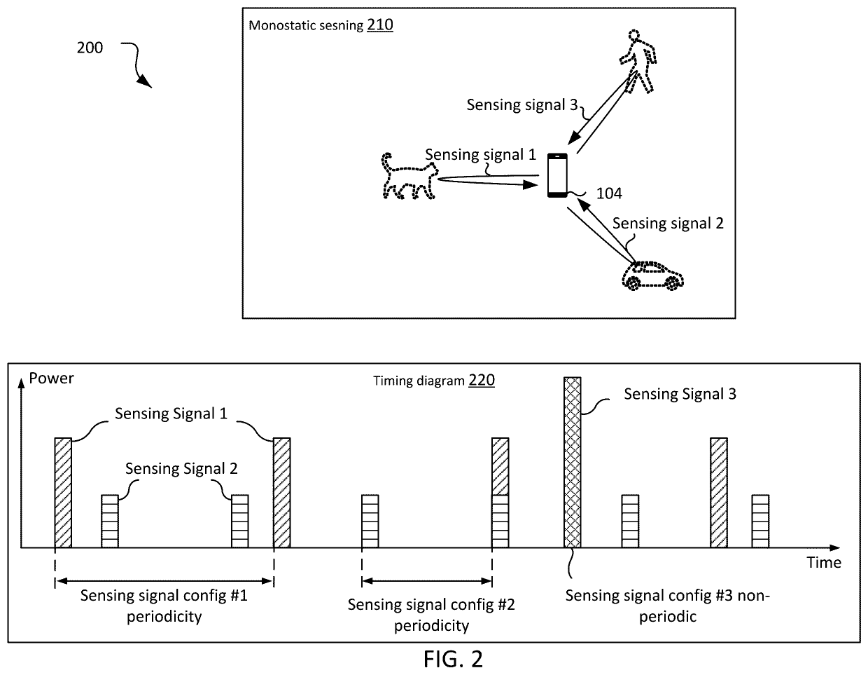

FIG. 2 illustrates signaling and timing diagrams 200 in accordance with some embodiments. Signaling and timing diagrams 200 include monostatic sensing diagram 210 and timing diagram 220.

The UE 104 is configured with three sensing signal configurations. Sensing signal configuration 1 configures periodic sensing signal 1. Timing diagram 220 shows the periodicity of the sensing signal 1.

Sensing signal configuration 2 configures periodic sensing signal 2. Timing diagram 220 shows the periodicity of sensing signal 2. Sensing signal 2 has a smaller periodicity than sensing signal 1. The reception or measurement of the sensing signals may overlap in time. For example, the third instance of the sensing signal 1 and the fourth instance of the sensing signal 2 in timing diagram 320 occur at the same time. Sensing signal 2 may have a smaller power level, as depicted by the amplitude of the representative pulse signals.

Sensing signal configuration 3 configures non-periodic sensing signal 3. In one instance, sensing signal 3 is transmitted after a predefined time from receiving sensing signal configuration 3. For example, sensing signal 3 may be transmitted/seconds after receiving the sensing signal configuration 3. In another example, the UE 104 may be configured with sensing signal configuration 3, and the UE 104 transmits sensing signal 3 after receiving a triggering event. For example, the triggering event may be an indication in downlink control information (DCI) or a medium access control (MAC) control element (CE).

The resources for each sensing signal configuration may be determined by a RAN, e.g., the BS, or a core network entity in charge of sensing. When resources are allocated by a core network entity, one or more BSs may provide information relating to radio resources available for sensing to the core network entity. The core network entity may allocate resources for sensing signals and provide them to the UE 104.

Each sensing signal configuration 1-3 may have different parameters. For example, the parameters configured by each sensing signal configuration 1-3 may include a periodic or non-periodic indicator, beam width or beam direction, power level, radio resource for sensing signal transmission, and radio resource for measurement.

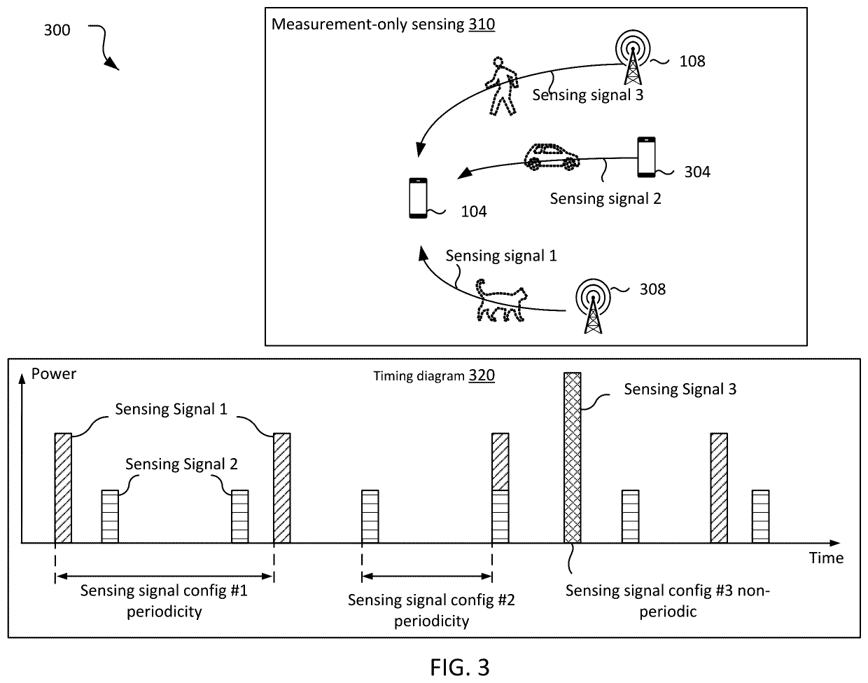

FIG. 3 illustrates signaling and timing diagrams 300 in accordance with some embodiments. Signaling and timing diagrams 300 include measurement-only sensing diagram 310 and timing diagram 320.

The UE 104 is configured with three sensing signal configurations. The sensing signal configurations 1-3 may not configure the UE to transmit the sensing signals 1-3. Instead, the sensing signal configurations 1-3 may configure the UE 104 to perform measurement of some sensing signals transmitted by other network nodes, e.g., a BS or another UE. The UE's configuration in this example may be called a measurement-only sensing configuration.

Sensing signal configuration 1 configures resources/parameters for detecting the periodic sensing signal 1. The UE 104, periodically and at configured time slots, receives or measures the configured sensing signal 1 on the configured resources, e.g., time and frequency resources. In one example, the time and frequency resources may include resource elements, resource blocks, subcarrier numbers, or symbol number information or indications. The UE 104 may not be configured with the information about the transmitter of the sensing signal 1. In one example, sensing signal 1 may be transmitted from BS 308, with which the UE 104 may not be coupled. Timing diagram 220 shows the periodicity of the sensing signal 1.

Sensing signal configuration 2 configures resources/parameters for detecting the periodic sensing signal 2. The UE 104, periodically and at configured time slots, receives or measures the configured sensing signal 2 on the configured resources, e.g., time and frequency resources. In one example, sensing signal 2 may be transmitted from the UE 304, a UE with which the UE 104 may not be coupled. Timing diagram 220 shows the periodicity of sensing signal 2. Sensing signal 2 has a smaller periodicity than sensing signal 1, and in one instance, the reception or measurement of sensing signal 2 overlaps with sensing signal 1. Sensing signal 2 may have a smaller power level, as depicted by the amplitude of the representative pulse signals.

Sensing signal configuration 3 configures resources/parameters for detecting the non-periodic sensing signal 3. In one instance, sensing signal 3 is measured in response to a triggering event. For example, sensing signal 3 may be received or measured s seconds after receiving the triggering event. For example, the triggering event may be an indication in a DCI or a MAC CE.

Each sensing signal configuration 1-3 may have different parameters. For example, the parameters configured by each sensing signal configuration 1-3 may include a periodic or non-periodic indicator, beam width or beam direction, power level, and radio resource for measurement. Radio resources for measurement may include time and frequency resources.

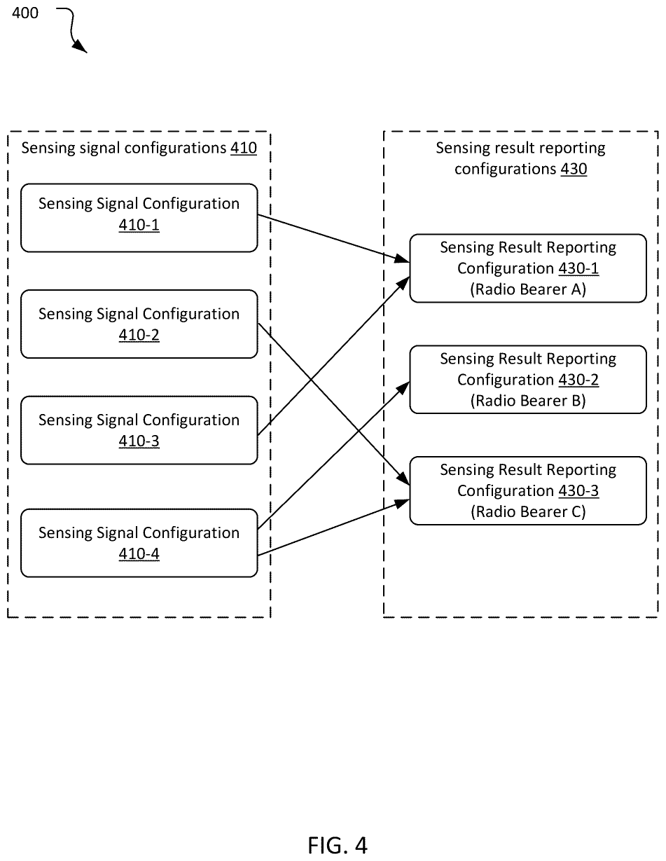

FIG. 4 illustrates configuration diagram 400 in accordance with some embodiments. A UE, e.g., the UE 104 in FIG. 1, may be configured with one or more sensing signal configurations 410, e.g., sensing signal configuration 410-1 to 410-4. Each sensing signal configuration 410 may be associated with one or more sensing result reporting configurations 430. For example, as shown, sensing signal configuration 410-1 is associated with sensing result reporting configuration 430-1, sensing result reporting configuration 410-2 is associated with sensing result reporting configuration 430-3, sensing result reporting configuration 410-3 is associated with sensing result reporting configuration 430-1, and sensing result reporting configuration 410-4 is associated with sensing result reporting configurations 430-2 and 430-3.

For a sensing signal configuration mapped or associated with multiple sensing results reporting configurations, the UE may obtain measurements from one sensing signal and report the measurements based on the different reporting configurations. Consider, for example, sensing signal configuration 410-4 associated with sensing result reporting configurations 430-2 and 430-3. The UE may obtain measurements from a sensing signal configured by the sensing signal configuration 410-4 and use the reports as a basis for two different reports. The first report may be sent on radio bearer B, based on sensing result reporting configuration 430-2, and the second report may be sent on radio bearer C, based on sensing result reporting configuration 430-3.

Each sensing result reporting configuration 430 may include periodic or event-triggered reporting indication, reporting periodicity, radio resources for reporting, or radio bearer selection. The radio bearer in each reporting configuration 430 may be a signaling radio bearer (SRB) or a data radio bearer (DRB).

In one instance, an SRB is selected in reporting configuration 430. The sensing result may be reported on an access stratum (AS) or a non-access stratum (NAS) message. For example, the sensing result may be reported on a NAS message mapped to SRB2 that is received by the core network.

To maintain the sensing QoS requirements, the network may further configure radio bearer parameters, e.g., radio link control (RLC) mode or logical channel (LCH) priority. Different radio bearers may have different destinations, e.g., RAN or core network. The network may associate sensing signal configuration 410 to sensing result reporting configuration 430 at least in part based on the QoS or destination of the radio bearer associated with the sensing result reporting configuration 430.

For example, the sensing result obtained based on sensing signal configuration 410-2 is configured to be reported based on the sensing result reporting configuration 430-3 on radio bearer C.

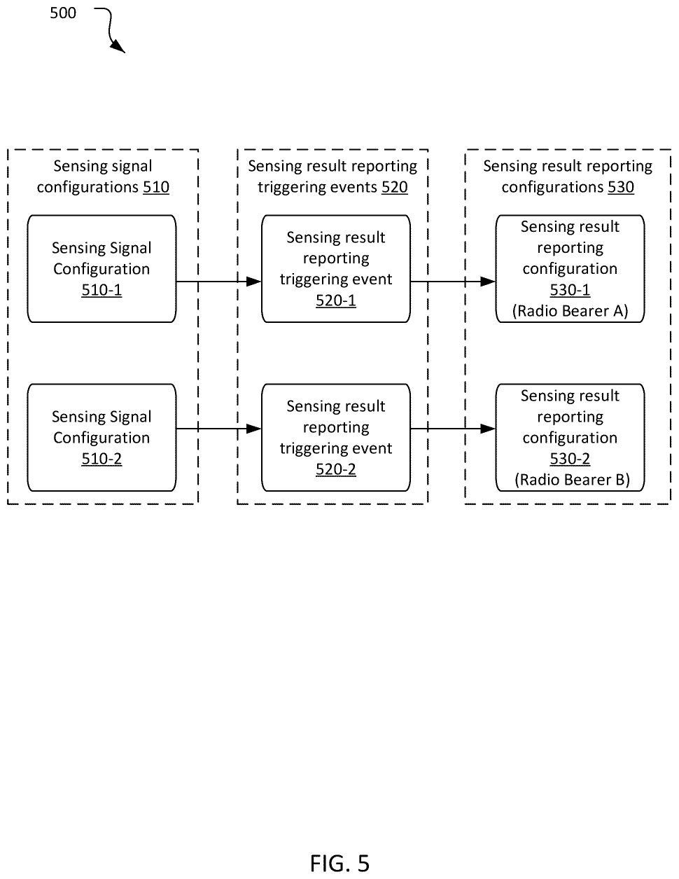

FIG. 5 illustrates configuration diagram 500 in accordance with some embodiments. In one embodiment, when the UE is configured with non-periodic reporting, the UE may report the measurement obtained from a sensing signal configuration 510 based on the associated sensing result reporting configuration 530 when the associated sensing result reporting triggering event 520 has occurred.

For example, sensing signal configuration 510-1 is associated with sensing result reporting configuration 530-1. The UE would report the result on radio bearer A based on the configuration 530-1 when the triggering event 520-1 has occurred. Similarly, sensing signal configuration 510-2 is associated with sensing result reporting configuration 530-2. The UE would report the result on radio bearer B based on the configuration 530-2 when the triggering event 520-2 has occurred.

The triggering event may be related to the sensing results itself. For example, suppose the purpose of sensing is detecting the presence of a condition or an object. In that case, the triggering event may be the positive detection of the presence of the condition or the object. For example, a sensing signal configured for detecting rainfall may trigger reporting upon detecting raindrops or alternatively may trigger reporting when the precipitation rate exceeds a pre-configured threshold.

In one instance, the triggering event causes the transmission of the report. For example, the UE may send the sensing result report in u seconds after receiving the triggering event 520. In some instances, the triggering event causes the UE to request resources for UL transmission of the sensing result report and may send the report on the resources allocated by the BS in response to UE's UL grant request.

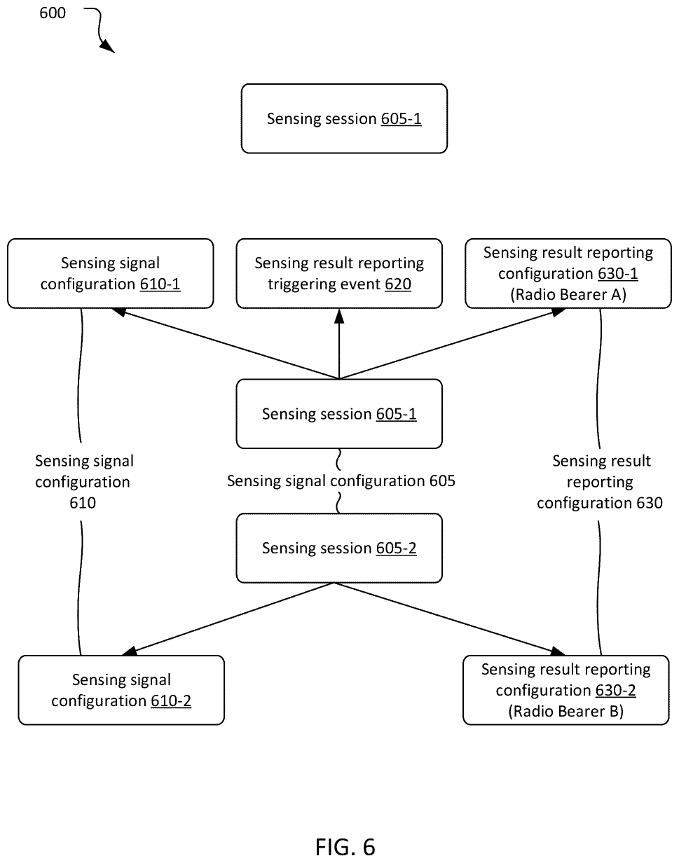

FIG. 6 illustrates configuration diagram 600 in accordance with some embodiments. The UE may be configured with a sensing session 605, e.g., sensing sessions 605-1 or 605-2. The sensing session 605 may include a sensing signal configuration 610, e.g., sensing signal configuration 610-1 or 610-2. The sensing session 605 may include a sensing result reporting configuration 630, e.g., sensing result reporting configuration 630-1 or 630-2. Each sensing session may correspond to a different sensing service request, and the corresponding sensing result reporting configuration may be selected based on the QoS requirement of the service request.

In one embodiment, the sensing session 605 may include an indication of the sensing signal configuration or an indication of the sensing result reporting configuration. For example, the BS may separately configure the sensing signal configurations and sensing result reporting configurations and include an index or identification of a sensing signal configuration and sensing result reporting configuration in the sensing session 605.

The sensing session 605-1 includes sensing signal configuration 610-1, sensing result reporting configuration 630-1 mapped to radio bearer A, and sensing result reporting triggering event 620. Sensing session 605-1 may be an example of a sensing session configuration of non-periodic sensing or measurement-only sensing.

Sensing session 605-2 includes sensing signal configuration 610-2 and sensing result reporting configuration 630-2 mapped to the radio bearer B. The sensing session 605-2 may be an example of a sensing session configuration of periodic sensing or monostatic sensing.

The sensing signal configuration and sensing result reporting configuration may be embedded in the sensing signal configuration or may be configured separately and indicated in the sensing session configuration by their IDs.

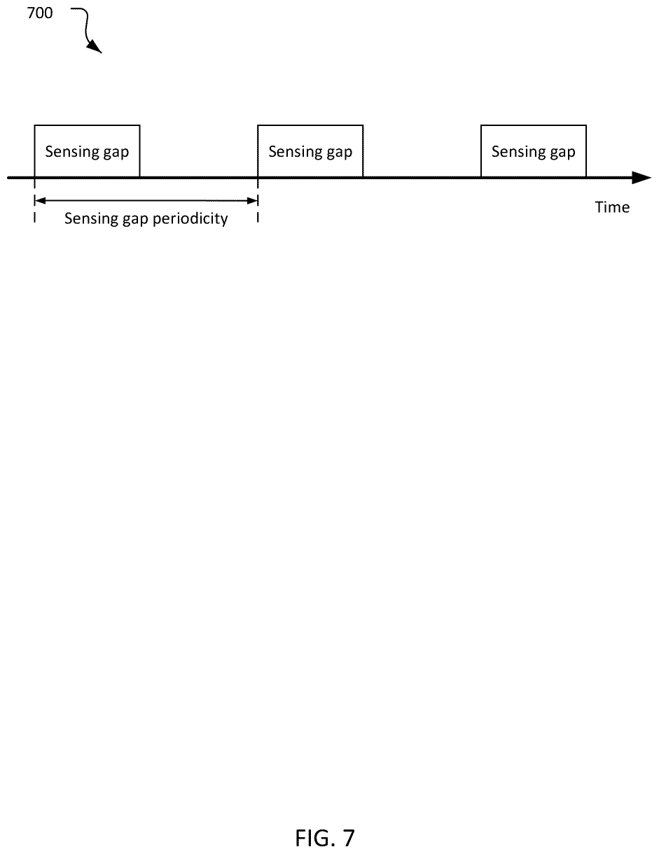

FIG. 7 illustrates a timing diagram 700 in accordance with some embodiments. The UE may be configured with sensing gaps. A sensing gap may be a time interval in which sensing signal transmission or measurements are allowed. The UE may not perform sensing signal transmission or measurement outside the sensing gaps.

The BS sends a sensing gap configuration to the UE to configure the time intervals in which the UE is permitted to send or receive sensing signals. The sensing gap may be periodic or non-periodic, and the sensing gap configuration may include an indication of whether the sensing gap is periodic. In one example, the network may dynamically activate a non-periodic (one-shot) sensing gap. The network may dynamically terminate an ongoing sensing gap early, whether the sensing gap is periodic or non-periodic. The network may dynamically activate or deactivate a periodic sensing gap. The network may send a command, e.g., using DCI or MAC CE, to activate, deactivate, or terminate a sensing gap.

In one example, the UE may conditionally activate a non-periodic (one-shot) sensing gap. The UE may conditionally terminate an ongoing sensing gap early. The UE may conditionally activate or deactivate a periodic sensing gap.

The UE may provide its preference to the network on how the configured sensing gap may be modified or if it should be released. For example, the UE may provide its preferences via UE assistance information. The UE assistance information is a special radio resource control (RRC) message. The UE can inform the network of its internal status using the UE assistance information message. The network may assign or control resources based on the message.

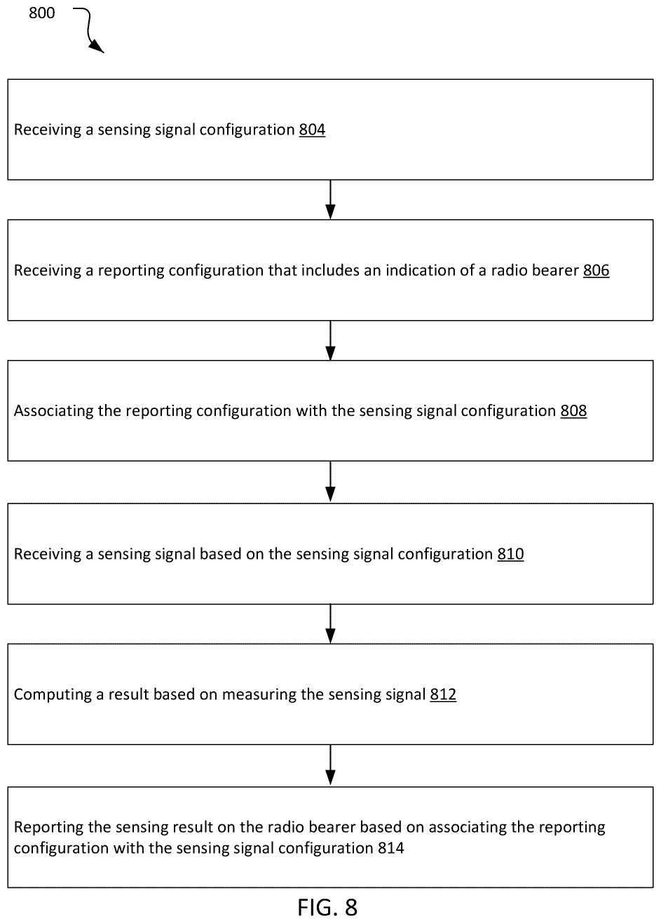

FIG. 8 illustrates operational flow/algorithmic structure 800 in accordance with some embodiments. Operational flow/algorithmic structure 800 is an example of operating a UE to provide a sensing result report on a radio bearer based on the reporting configuration associated with the sensing signal configuration. The operational flow/algorithmic structure 800 may be implemented by a UE, for example, the UE 104, the UE 1000, or components therein, e.g., processors 1004.

The operational flow/algorithmic structure 800 may include, at 804, receiving a sensing signal configuration. The sensing signal configuration may indicate whether the sensing signal is a periodic sensing signal, the beam width or direction of the sensing signal, the power level of the sensing signal, the radio resource set for the transmission or reception of the sensing signal, or the radio resource set for measuring the sensing signal.

In some embodiments, the UE may provide its capability relating to sensing features to the network in advance of receiving the sensing signal configuration at 804. The UE may support all or some of the sensing features. Sensing features may include sensing signal transmission, sensing signal measurement, sensing result derivation, and sensing result reporting. The UE may provide information relating to sensing features it can support, and the network may configure the sensing tasks at the UE based on the UE capabilities.

For example, a UE that can support both sensing signal transmission and sensing signal measurement may be configured by the BS to perform monostatic sensing. In another example, a UE that can only support sensing signal transmission may be configured by the BS to act only as the transmitter in bistatic sensing. In another example, a UE that can only support sensing signal measurement may be configured by the BS to act as the receiver in bistatic sensing.

The operational flow/algorithmic structure 800 may include, at 806, receiving a reporting configuration that indicates a radio bearer. The reporting configuration is an example of the sensing result reporting configuration. The reporting configuration may include reporting periodicity or a radio resource set for reporting.

The operational flow/algorithmic structure 800 may include, at 808, associating the reporting configuration with the sensing signal configuration. In one example, the reporting configuration is embedded in the sensing signal configuration. In one example, the sensing signal configuration is associated with a reporting configuration by including a reporting configuration ID of the reporting configuration.

In one example, the sensing signal configuration is associated with the reporting configuration by their association with the same sensing session. The operational flow/algorithmic structure 800 may include receiving a sensing session configuration that includes a reporting configuration, or a reporting configuration indication associated with the reporting configuration, and a sensing signal configuration or a sensing signal configuration indication associated with the sensing signal configuration.

The operational flow/algorithmic structure 800 may include, at 810, measuring a sensing signal based on the sensing signal configuration. For example, the UE may measure the signal strength or quality of the received sensing signal (e.g., RSRP and RSRQ), estimate the delay spread and channel impulse response, compute the angle of arrival, or estimate the doppler shift.

The operational flow/algorithmic structure 800 may include, at 812, computing a result based on measuring the sensing signal. In some embodiments, the computed result may be a measurement result (e.g., the result of measuring the sensing signal) or may be based on the measurement result. If the computed result is based on the measurement result, the UE may perform algorithms based on the measurement results to compute sensing results related to, for example, the presence, location, velocity, or direction of the movement of an object of interest. The UE may perform other signal processing algorithms to extract information, such as electromagnetic interference, humidity, or remote sensing processing. When the computed results are the measurement results, the network or the entity that receives the measurement results (e.g., an application or a client) may use the measurement results to compute the sensing results. The sensing configuration may configure the UE to compute/report the measurement or sensing results.

The operational flow/algorithmic structure 800 may include, at 814, reporting the result on the radio bearer based on associating the reporting configuration with the sensing signal configuration. The reporting includes generating a report and transmitting the report. For non-periodic reporting, the operational flow/algorithmic structure 800 may include receiving a reporting triggering event and reporting the result based on the triggering event.

The network, e.g., the BS, may dynamically control the sensing signal configuration, sensing result reporting configuration, or sensing sessions. The network may dynamically control the association between the sensing signal configuration and the sensing result reporting configuration. The network may dynamically control the association among sensing session, sensing signal configuration, and sensing result reporting configuration.

In one embodiment, the UE may not immediately apply the sensing signal configurations or sensing result reporting configuration once configured. Instead, the UE may apply the sensing signal configuration or sensing result reporting configuration when the BS activates them via layer 1 or layer 2 signals or when the UE activates them autonomously based on detecting a triggering event or a condition. For example, the UE may receive a command in a DCI to dynamically activate the sensing configuration. In another example, the UE may receive the command via a MAC CE to dynamically activate the sensing signal configuration.

The UE may conditionally activate, deactivate, modify, suspend, or release a sensing signal configuration. The UE may conditionally activate, deactivate, modify, suspend, or release a sensing result reporting configuration. The UE may conditionally activate, deactivate, modify, or release a sensing session. The condition may be detecting, occurring, or receiving a triggering event.

The UE may suspend or release a sensing signal configuration when it moves to RRC-IDLE or RRC-INACTIVE state from RRC-CONNECTED state. In some embodiments, the network may instruct the UE whether it should keep a configuration relating to sensing signal or sensing result reporting when entering RRC-IDLE or RRC-INACTIVE state. For example, the network may instruct the UE by RRC-Reconfiguraiton message or RRC-Release message.

In some embodiments, the UE may continue to perform sensing signal transmission or measurement even when it is in RRC-IDLE or RRC-INACTIVE state, and it may report the sensing result by using small data transmission (SDT) or by returning to the RRC-CONNECTED state proactively. Alternatively, it may store the sensing results and only report them when returning to the RRC-CONNECTED state. The network may also page the UE to initiate the sensing result reporting procedure when it is in RRC-IDLE or RRC-INACTIVE state.

The UE may provide its preference related to the activation, deactivation, modification, or release of a configured sensing signal configuration, a sensing result reporting configuration, or a sensing session. For example, the UE may indicate whether it prefers to keep the configured sensing signal configuration or sensing result reporting configuration when it enters RRC-IDLE or RRC-INACTIVE state. The UE may provide its preference via UE assistance information. For example, the UE may send UE assistance information to provide its preference on how or when a configured sensing session configuration can be released.

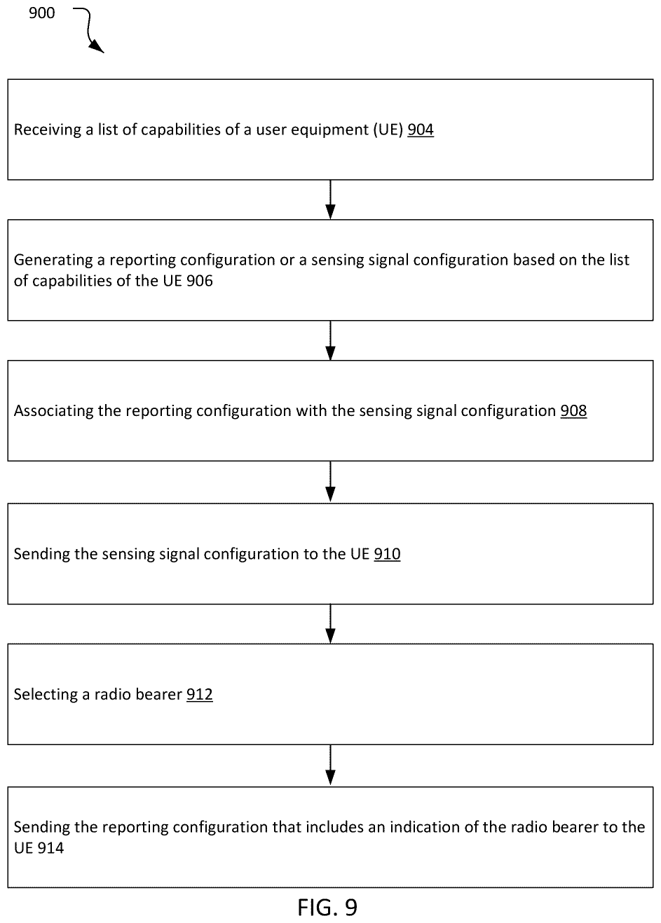

FIG. 9 illustrates operational flow/algorithmic structure 900 in accordance with some embodiments. Operational flow/algorithmic structure 900 is an example of operating a UE to provide a sensing result report on a radio bearer based on the reporting configuration associated with the sensing signal configuration. The operational flow/algorithmic structure 900 may be implemented by a UE, for example, the UE 104, the UE 1000, or components therein, e.g., processors 1004.

The operational flow/algorithmic structure 900 may include, at 904, receiving a list of capabilities of the UE. The capabilities list may include information related to sensing features, e.g., sensing signal transmission capabilities, sensing signal reception or measurement capabilities, sensing result derivation capabilities, and sensing result reporting capabilities. The UE may support all or some of the sensing features.

The operational flow/algorithmic structure 900 may include, at 906, generating a reporting configuration or a sensing signal configuration based on the list of capabilities. The sensing signal configuration may include an indication of whether a sensing signal is transmitted periodically or non-periodically, a beam width or direction of the sensing signal, a power level of the sensing signal, a radio resource set for a transmission of the sensing signal, or a radio resource set for reception of the sensing signal.

The operational flow/algorithmic structure 900 may include, at 908, associating the reporting configuration with the sensing signal configuration. In one example, the reporting configuration is embedded in the sensing signal configuration. In one example, the sensing signal configuration is associated with a reporting configuration by including a reporting configuration ID of the reporting configuration. In another example, the reporting configuration is associated with the sensing signal configuration by having a sensing signal configuration ID of the sensing signal configuration.

In one example, the sensing signal configuration is associated with the reporting configuration by their association with the same sensing session. The operational flow/algorithmic structure 900 may include sending a sensing session configuration to the UE that includes a reporting configuration, a reporting configuration indication associated with the reporting configuration, and a sensing signal configuration or a sensing signal configuration associated with the sensing signal configuration.

The operational flow/algorithmic structure 900 may include, at 910, sending the sensing signal configuration to the UE. For example, the BS may use radio resource control (RRC) signaling to send the sensing signal configuration.

The operational flow/algorithmic structure 900 may include, at 912, selecting a radio bearer. The BS may receive a sensing service request, e.g., from a client, a user, or an application. The sensing service request may be associated with QoS features and requirements. The BS may select the radio bearer based on the QoS requirements of the sensing service request. For example, the BS may select a radio bearer that meets the round trip time requirement of the sensing. If an appropriate radio bearer is not configured, the BS may configure a radio bearer and maps the sensing session or the sensing reporting configuration to it.

The operational flow/algorithmic structure 900 may include, at 914, sending the reporting configuration that indicates the selected radio bearer to the UE. For example, the BS may use radio resource control (RRC) signaling to send the sensing signal configuration.

The operational flow/algorithmic structure 900 may include configuring a sensing gap and sending the sensing gap configuration to the UE. The UE may provide its internal status and preferences regarding the configuration of the sensing gap to the BS, and the BS may configure the sensing gap based on the UE's preferences and internal status. The UE may provide its preferences using the RRC signaling. For example, the UE may use the RRC UE assistance information message to send its preferences or internal status related to the sensing signal configuration, sensing result reporting configuration, sensing session configuration, or sensing gap configuration to the BS.

The network may activate, deactivate, modify, or release a configured sensing signal configuration, sensing result reporting configuration, or sensing session by sending a command to the UE. The command may be included in a MAC CE, a DCI, or a dedicated RRC message.

The network, e.g., the BS, may dynamically activate, deactivate, modify, or release a sensing signal configuration. The network may dynamically activate, deactivate, modify, or release a sensing result reporting configuration. The network may dynamically activate, deactivate, modify, or release a sensing session.

The network may receive the UE's preference on how, if, or when a configured sensing signal configuration, a sensing result reporting configuration, or a sensing session should be activated, deactivated, modified, or released. The network may receive the UE's preference via UE assistance information message. The BS may activate, deactivate, modify, or release a configured sensing session configuration, sensing result reporting configuration, or sensing session, at least in part, based on the UE's preference.

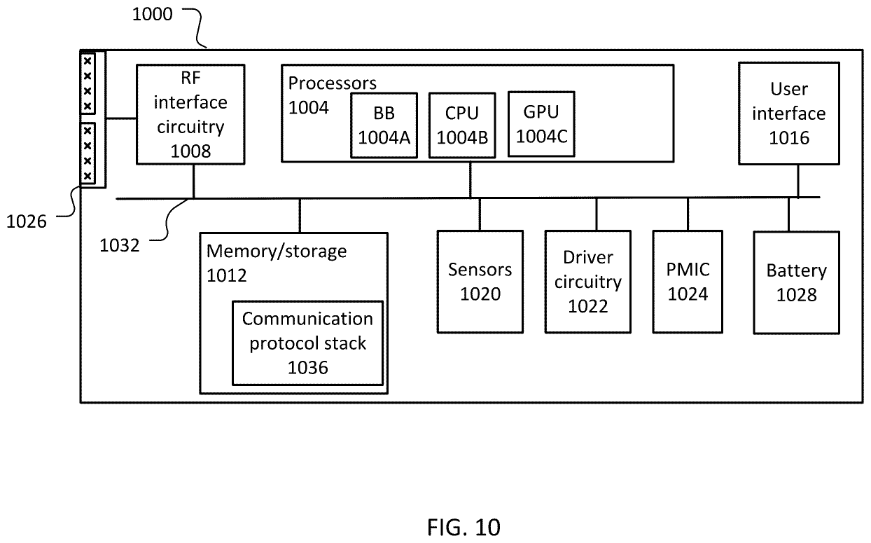

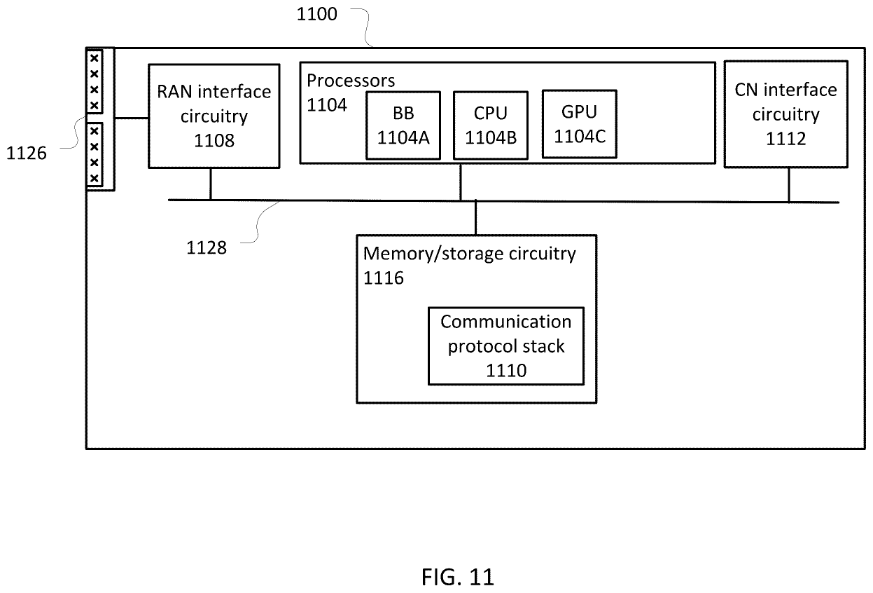

FIG. 10 illustrates a UE 1000 in accordance with some embodiments. The UE 1000 may be similar to and substantially interchangeable with UE 104 of FIG. 1.

The UE 1000 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

The processors 1004 may perform operations associated with measuring sensing signals and reporting sensing measurement results on a radio bearer configured for reporting sensing measurements. For example, the processors 1004 may receive the sensing signal configuration and the associated reporting configuration, generate a report and send it to the RF interface circuitry to be transmitted on the radio bearer configured by the reporting configuration.

In some embodiments, the baseband processor circuitry 1004A may access a communication protocol stack 1036 in the memory/storage 1012 to communicate over a 3GPP-compatible network. In general, the baseband processor circuitry 1004A may access the communication protocol stack 1036 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1012 may include one or more non-transitory, computer-readable media that includes instructions (for example, the communication protocol stack 1036) that may be executed by one or more of the processors 1004 to cause the UE 1000 to perform various operations described herein. The memory/storage 1012 includes any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processor 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands, including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs) or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various I/O devices that may be present within or connected to the UE 1000. For example, the driver circuitry 1022 may include circuitry to facilitate the coupling of a universal integrated circuit card (UICC) or a universal subscriber identity module (USIM) to the UE 1000. For additional examples, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage the power provided to various components of the UE 1000. In particular, with respect to the processors 1004, the PMIC 1024 may control power-source selection, voltage scaling, battery charging, or DC-to-DC conversion.

In some embodiments, the PMIC 1024 may control or otherwise be part of various power-saving mechanisms of the UE 1000, including DRX, as discussed herein.

A battery 1028 may power the UE 1000, although, in some examples, the UE 1000 may be mounted and deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

FIG. 11 illustrates a network node 1100 in accordance with some embodiments. The network node 1100 may be similar to and substantially interchangeable with base station 108, a device implementing one of the network hops, an integrated access and backhaul (IAB) node, a network-controlled repeater, or a server in a core network or external data network.

The network node 1100 may include processors 1104, RF interface circuitry 1108 (if implemented as an access node), the core node (CN) interface circuitry 1112, memory/storage circuitry 1116, and antenna structure 1126.

The components of the network node 1100 may be coupled with various other components over one or more interconnects 1128.

The processors 1104, RF interface circuitry 1108, memory/storage circuitry 1116 (including communication protocol stack 1110), antenna structure 1126, and interconnects 1128 may be similar to like-named elements shown and described with respect to FIG. 10.

The processors 1104 may perform operations associated with configuring a UE to perform sensing measurements and reporting the results on a configured radio bearer. For example, the processors 1104 may receive the UE capabilities, and configure the UE with sensing signal configuration and sensing result reporting configuration, including a radio bearer allocated for report transmission, based on the UE capabilities.

The CN interface circuitry 1112 may provide connectivity to a core network, for example, a 5th Generation Core network (5GC) using a 5GC-compatible network interface protocol such as carrier Ethernet protocols or some other suitable protocol. Network connectivity may be provided to/from the network node 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

In some embodiments, the network node 1100 may be coupled with transmit-receive points (TRPs) using the antenna structure 1126, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method of operating a user equipment (UE), the method including: receiving a sensing signal configuration; receiving a reporting configuration that includes an indication of a radio bearer; associating the reporting configuration with the sensing signal configuration; receiving a sensing signal based on the sensing signal configuration; computing a result based on the sensing signal; and reporting the result on the radio bearer based on associating the reporting configuration with the sensing signal configuration.

Example 2 includes the method of example 1 or some other examples herein, wherein the sensing signal configuration is to indicate: whether the sensing signal is a periodic sensing signal; a beam width or direction of the sensing signal; a power level of the sensing signal; a first radio resource set for a transmission of the sensing signal; or a second radio resource set for said measuring the sensing signal.

Example 3 includes the method of any of examples 1 or 2 or some other examples herein, wherein the reporting configuration further includes a reporting periodicity or a radio resource set for reporting.

Example 4 includes the method of any of examples 1-3 or some other examples herein, wherein said associating the reporting configuration with the sensing signal configuration is based on a reporting identification (ID) included in the reporting configuration or the sensing signal configuration.

Example 5 includes the method of any of examples 1-4 or some other examples herein, wherein the sensing signal configuration includes the reporting configuration.

Example 6 includes the method of any of examples 1-5 or some other examples herein, the method further including: detecting a condition; and performing an activation, a deactivation, a modification, or a release of the sensing signal configuration or the reporting configuration based on the condition.

Example 7 includes the method of any of examples 1-6 or some other examples herein, the method further including: receiving a sensing session configuration, the sensing session configuration is to include a reporting configuration indication associated with the reporting configuration and a sensing signal configuration indication associated with the sensing signal configuration.

Example 8 includes the method of any of examples 1-7 or some other examples herein, wherein the sensing session configuration is associated with a quality of service requirement.

Example 9 includes the method of any of examples 1-8 or some other examples herein, wherein said associating the reporting configuration with the sensing signal configuration is based on the sensing session configuration.

Example 10 includes the method of any of examples 1-9 or some other examples herein, the method further including: receiving an indication; and performing an activation, a deactivation, a modification, or a release of the sensing signal configuration, the reporting configuration, or the sensing session configuration based on the indication.

Example 11 includes the method of any of examples 1-10 or some other examples herein, the method further including: transmitting the sensing signal based on the sensing signal configuration; and receiving a reflection of the sensing signal, wherein said measuring of the sensing signal is based on said receiving of the reflection of the sensing signal.

Example 12 includes the method of any of examples 1-11 or some other examples herein, the method further including: receiving a sensing triggering event, wherein said transmitting of the sensing signal is based on said receiving of the sensing triggering event.

Example 13 includes the method of any of examples 1-12 or some other examples herein, wherein the sensing triggering event is included in a downlink control information (DCI) or a medium access control (MAC) control element (CE).

Example 14 includes the method of any of examples 1-13 or some other examples herein, wherein the radio bearer is a signaling radio bearer or a data radio bearer.

Example 15 includes the method of any of examples 1-14 or some other examples herein, the method further including: receiving a reporting triggering event, wherein said reporting of the result is based on said receiving of the reporting triggering event.

Example 16 includes the method of any of examples 1-15 or some other examples herein, wherein the reporting triggering event is based on the result, a downlink control information (DCI), or a medium access control (MAC) control element (CE).

Example 17 includes the method of any of examples 1-16 or some other examples herein, the method further including: receiving a sensing gap configuration to indicate a time interval; and transmitting or measuring the sensing signal based on the time interval.

Example 18 includes the method of any of examples 1-17 or some other examples herein, wherein the sensing gap configuration further indicates whether the time period is a periodic time period or a non-periodic time period.

Example 19 includes the method of any of examples 1-18 or some other examples herein, the method further including: receiving a command; and performing an activation, a deactivation, a modification, a termination, or a release of the sensing gap configuration based on the command.

Example 20 includes the method of any of examples 1-19 or some other examples herein, further including: detecting a condition; and performing an activation, a deactivation, a modification, a termination, or a release of the sensing gap configuration based on the condition.

Example 21 incudes a method of operating a base station (BS), the method including: receiving a list of capabilities of a user equipment (UE); generating a reporting configuration and a sensing signal configuration based on the list of capabilities of the UE; associating the reporting configuration with the sensing signal configuration; sending the sensing signal configuration to the UE; selecting a radio bearer; and sending the reporting configuration that includes an indication of the radio bearer to the UE.

Example 22 includes the method of example 21 or some other examples herein, the method further includes receiving a result on the radio bearer based on the reporting configuration.

Example 23 includes the method of any of examples 21 or 22 or some other examples herein, wherein: the reporting configuration includes a reporting configuration identification, and said associating the reporting configuration with the sensing signal configuration is based on the reporting configuration identification; or the sensing signal configuration includes a sensing signal configuration identification, and said associating the reporting configuration with the sensing signal configuration is based on the sensing signal configuration identification.

Example 24 includes the method of any of examples 21-23 or some other examples herein, wherein the reporting configuration is embedded in the sensing signal configuration.

Example 25 includes the method of any of examples 21-24 or some other examples herein, wherein the sensing signal configuration includes an indication of whether a sensing signal is transmitted periodically or non-periodically, a beam width or direction of the sensing signal, a power level of the sensing signal, a first radio resource set for a transmission of the sensing signal, or a second radio resource set for a reception of the sensing signal.

Example 26 includes the method of any of examples 21-25 or some other examples herein, wherein the radio bearer is a signaling radio bearer (SRB) or a data radio bearer (DRB).

Example 27 includes the method of any of examples 21-26 or some other examples herein, the method further including sending a sensing session configuration to the UE, the sensing session configuration is to include a reporting configuration indication associated with the reporting configuration and a sensing signal configuration indication associated with the sensing signal configuration.

Example 28 includes the method of any of examples 21-27 or some other examples herein, wherein the sensing session includes an indication of a triggering event associated with the reporting configuration.

Example 29 includes the method of any of examples 21-28 or some other examples herein, the method further including sending a command to the UE to activate, deactivate, modify, or release the sensing session.

Example 30 includes the method of any of examples 21-29 or some other examples herein, wherein the command is included in a downlink control information (DCI) or a medium access control (MAC) control element (CE).

Example 31 includes the method of any of examples 21-30 or some other examples herein, further including: generating a sensing gap configuration, sensing gap configuration including a time interval during which a transmission or a reception of a sensing signal is permitted; and sending the sensing gap configuration to the UE.

Example 32 includes the method of any of examples 12-31 or some other examples herein, further including sending a command to the UE to activate, deactivate, modify, or release the sensing gap.

Example 33 includes the method of any of examples 21-32 or some other examples herein, wherein the command is included in a downlink control information (DCI) or a medium access control (MAC) control element (CE).

Another example may include an apparatus comprising logic, modules, or circuitry to perform one or more elements of a method described in or related to any of examples 1-24, or any other method or process described herein.

Another example may include a method, technique, or process as described in or related to any of examples 1-33, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-33, or portions thereof.

Another example includes a signal as described in or related to any of examples 1-33, or portions or parts thereof.

Another example may include a datagram, information element, packet, frame, segment, PDU, or message as described in or related to any of examples 1-33, or portions or parts thereof, or otherwise described in the present disclosure.

Another example may include a signal encoded with data as described in or related to any of examples 1-33, or portions or parts thereof, or otherwise described in the present disclosure.

Another example may include a signal encoded with a datagram, IE, packet, frame, segment, PDU, or message as described in or related to any of examples 1-33, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-33, or portions thereof.

Another example may include a computer program comprising instructions, wherein execution of the program by a processing element is to cause the processing element to carry out the method, techniques, or process as described in or related to any of examples 1-33, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a sensing signal configuration;
processing a reporting configuration that includes an indication of a radio bearer;
associating the reporting configuration with the sensing signal configuration;
processing a sensing signal based on the sensing signal configuration;
computing a result based on the sensing signal; and
generating a signal to report the result on the radio bearer based on associating the reporting configuration with the sensing signal configuration.

2. The method of claim 1, wherein the sensing signal configuration is to indicate: whether the sensing signal is a periodic sensing signal; a beam width or direction of the sensing signal; a power level of the sensing signal; a first radio resource set for a transmission of the sensing signal; or a second radio resource set for performing a measurement of the sensing signal.

3. The method of claim 1, further comprising:
detecting a condition; and
performing an activation, a deactivation, a modification, or a release of the sensing signal configuration or the reporting configuration based on the condition.

4. The method of claim 1, further comprising:
processing a sensing session configuration, the sensing session configuration is to include a reporting configuration indication associated with the reporting configuration and a sensing signal configuration indication associated with the sensing signal configuration.

5. The method of claim 4, wherein:
the sensing session configuration is associated with a quality of service requirement;
said associating the reporting configuration with the sensing signal configuration is based on the sensing session configuration; and
the method further comprises:
generating an indication; and
performing an activation, a deactivation, a modification, suspension or a release of the sensing signal configuration, the reporting configuration, or the sensing session configuration based on the indication.

6. The method of claim 1, further comprising:
generating the sensing signal based on the sensing signal configuration; and
processing a reflection of the sensing signal, wherein said computing the result is based on said processing of the reflection of the sensing signal.

7. The method of claim 6, further comprising:
processing a sensing triggering event, wherein said generating of the sensing signal is based on said processing of the sensing triggering event, and the sensing triggering event is included in a downlink control information (DCI) or a medium access control (MAC) control element (CE).

8. The method of claim 1, further comprising:
processing a reporting triggering event, wherein said reporting of the result is based on said processing of the reporting triggering event, wherein the reporting triggering event is based on the result, a downlink control information (DCI), or a medium access control (MAC) control element (CE).

9. The method of claim 1, further comprising:
processing a sensing gap configuration to indicate a time interval;
generating or measuring the sensing signal based on the time interval;
processing a command;
detecting a condition; and
performing an activation, a deactivation, a modification, a termination, or a release of the sensing gap configuration based on the command or the condition.

10. An apparatus comprising:
processing circuitry configured to
process a sensing signal configuration;
process a reporting configuration that includes an indication of a radio bearer;
associate the reporting configuration with the sensing signal configuration;
process a sensing signal based on the sensing signal configuration;
compute a result based on the sensing signal; and
generate a signal to report the result on the radio bearer based on associating the reporting configuration with the sensing signal configuration; and
memory interface circuitry coupled with the processing circuitry, to store the indication of the radio bearer in a memory.

11. The apparatus of claim 10, wherein the sensing signal configuration is to indicate: whether the sensing signal is a periodic sensing signal; a beam width or direction of the sensing signal; a power level of the sensing signal; a first radio resource set for a transmission of the sensing signal; or a second radio resource set for performing a measurement of the sensing signal.

12. The apparatus of claim 10, wherein the processing circuitry is further configured to:
detect a condition; and
perform an activation, a deactivation, a modification, or a release of the sensing signal configuration or the reporting configuration based on the condition.

13. The apparatus of claim 10, wherein the processing circuitry is further configured to:
process a sensing session configuration, the sensing session configuration is to include a reporting configuration indication associated with the reporting configuration and a sensing signal configuration indication associated with the sensing signal configuration.

14. The apparatus of claim 10, wherein the processing circuitry is further configured to:
generate the sensing signal based on the sensing signal configuration; and
process a reflection of the sensing signal, wherein said compute the result is based on said process of the reflection of the sensing signal.

15. The apparatus of claim 14, wherein the processing circuitry is further configured to:
generate a sensing triggering event, wherein said generate of the sensing signal is based on said process of the sensing triggering event, and the sensing triggering event is included in a downlink control information (DCI) or a medium access control (MAC) control element (CE).

16. The apparatus of claim 10, wherein the processing circuitry is further configured to:
process a sensing gap configuration to indicate a time interval;
generate or measure the sensing signal based on the time interval;
process a command;
detect a condition; and
perform an activation, a deactivation, a modification, a termination, or a release of the sensing gap configuration based on the command or the condition.

17. One or more non-transitory computer-readable media having instructions that, when executed, cause processing circuitry to:
process a list of capabilities of a user equipment (UE);
select a radio bearer;
generate a reporting configuration and a sensing signal configuration based on the list of capabilities of the UE, the reporting configuration including an indication of the radio bearer; and
associate the reporting configuration with the sensing signal configuration.

18. The one or more non-transitory computer-readable media of claim 17, wherein:
the reporting configuration includes a reporting configuration identification, and said associate the reporting configuration with the sensing signal configuration is based on the reporting configuration identification; or
the sensing signal configuration includes a sensing signal configuration identification, and said associate the reporting configuration with the sensing signal configuration is based on the sensing signal configuration identification.

19. The one or more non-transitory computer-readable media of claim 17, wherein the instructions, when executed, further cause the processing circuitry to:
generate a sensing session configuration to be transmitted to the UE, the sensing session configuration is to include a reporting configuration indication associated with the reporting configuration, a sensing signal configuration associated with the sensing signal configuration, and an indication of a triggering event associated with the reporting configuration; and
generate a command to be transmitted to the UE to activate, deactivate, modify, or release the sensing session configuration, the command is included in a downlink control information (DCI) or a medium access control (MAC) control element (CE).

20. The one or more non-transitory computer-readable media of claim 17, wherein the instructions, when executed, further cause the processing circuitry to:
generate a sensing gap configuration to be transmitted to the UE, sensing gap configuration including a time interval during which a transmission or a reception of a sensing signal is permitted; and
generate a command to be transmitted to the UE to activate, deactivate, modify, or release the sensing gap configuration, the command is included in a downlink control information (DCI) or a medium access control (MAC) control element (CE).
